(19) United States
(12) Patent Application Publication
(10) Pub. No.: US 2024/0295672 A1
(43) Pub. Date: Sep. 5, 2024

(54) Polarization-Tuned Metasurface Device

(71) Applicant: Metalenz, Inc., Boston, MA (US)

(72) Inventors: Pawel Latawiec, Cambridge, MA (US); Mohammad Salary, Austin, TX (US)

(73) Assignee: Metalenz, Inc., Boston, MA (US)

(21) Appl. No.: 18/592,246

(22) Filed: Feb. 29, 2024

Related U.S. Application Data
(60) Provisional application No. 63/487,766, filed on Mar. 1, 2023.

(51) Int. Cl. G02B 1/00; G02B 27/28

(52) U.S. Cl. CPC G02B 1/002; G02B 27/285

(57) ABSTRACT

A metasurface device may include a metasurface including multiple metasurface elements configured to receive light including at least one of a first polarization or a second polarization with a diverging wavefront from a light source. The first polarization and the second polarization may be orthogonal. The metasurface elements may include an interior metasurface element which is substantially aligned to an axis and exterior metasurface elements which are rotated with respect to the axis. The exterior metasurface elements positioned farther away from the interior metasurface element may be more rotated than the exterior metasurface elements positioned closer to the interior metasurface element. The metasurface may be configured to diffract light with the first polarization into a first output light beam and/or light with the second polarization into a second output light beam.

### CROSS-REFERENCE TO RELATED APPLICATIONS

This application claims the benefit of and priority under 35 U.S.C. § 119(e) to U.S. Provisional Patent Application Ser. No. 63/487,766, entitled “Polarization-Tuned Metasurface Device” and filed Mar. 1, 2023, which is incorporated herein by reference in its entirety for all purposes.

### FIELD OF THE INVENTION

The present invention generally relates to metasurface devices that are tuned to handle non-collimated light sources.

### BACKGROUND

Metasurfaces include a plurality of metasurface elements. Metasurface elements are diffractive optical elements in which individual waveguide elements have subwavelength spacing and have a planar profile. Metasurface elements have recently been developed for application in the UV-IR bands (300-10,000 nm). Compared to traditional refractive optics, metasurface elements may abruptly introduce phase shifts onto light field. This enables metasurface elements to have thicknesses on the order of the wavelength of light at which they are designed to operate, whereas traditional refractive surfaces have thicknesses that are 10-100 times (or more) larger than the wavelength of light at which they are designed to operate. Additionally, metasurface elements may have no variation in thickness in the constituent elements and thus are able to shape light without any curvature, as typically included in refractive optics. Compared to traditional diffractive optical elements (DOEs), for example binary diffractive optics, metasurface elements have the ability to impart a range of phase shifts on an incident light field, at a minimum the metasurface elements can have phase shifts between 0-2π with at least 5 distinct values from that range, whereas binary DOEs are only able to impart two distinct values of phase shift and are often limited to phase shifts of either 0 or 1π. Compared to multi-level DOE's, metasurface elements do not require height variation of its constituent elements along the optical axis, only the in-plane geometries of the metasurface element features vary.

### SUMMARY OF THE DISCLOSURE

In some aspects, the techniques described herein relate to a metasurface device including: a metasurface including multiple metasurface elements configured to receive light including at least one of a first polarization or a second polarization with a diverging wavefront from a light source, wherein the first polarization and the second polarization are orthogonal, wherein the metasurface elements include an interior metasurface element which is substantially aligned to an axis and exterior metasurface elements which are rotated with respect to the axis, wherein the exterior metasurface elements positioned farther away from the interior metasurface element are more rotated than the exterior metasurface elements positioned closer to the interior metasurface element, and wherein the metasurface is configured to diffract light with the first polarization into a first output light beam and/or light with the second polarization into a second output light beam.

In some aspects, the techniques described herein relate to a metasurface device, wherein the light source includes a VCSEL array.

In some aspects, the techniques described herein relate to a metasurface device, wherein the VCSEL array includes interlaced vertical polarization VCSELs and horizontal polarization VCSELs which output light with a spherical wavefront.

In some aspects, the techniques described herein relate to a metasurface device, wherein the VCSEL array is configured to switch between light source is configured to output light from the vertical polarization VCSELs or the horizontal polarization VCSELs at distinctly different times.

In some aspects, the techniques described herein relate to a metasurface device, wherein the first output light beam has a different illumination pattern than the second output light beam.

In some aspects, the techniques described herein relate to a metasurface device, wherein the first output light beam has a more dispersed illumination pattern than the second output light beam.

In some aspects, the techniques described herein relate to a metasurface device, wherein the VCSEL array includes interlaced first polarization VCSELs and second polarization VCSELs, and wherein the first polarization VCSELs and second polarization VCSELs output light with opposite polarizations.

In some aspects, the techniques described herein relate to a metasurface device, wherein the first polarization VCSELs and the second polarization VCSELs output circularly polarized light.

In some aspects, the techniques described herein relate to a metasurface device, wherein the first polarization VCSELs and the second polarization VCSELs output elliptically polarized light.

In some aspects, the techniques described herein relate to a metasurface device, wherein the light received by the metasurface has a non-collimated wavefront.

In some aspects, the techniques described herein relate to a metasurface device, wherein the metasurface elements are rectangular with identical length and width.

In some aspects, the techniques described herein relate to a metasurface device, wherein the metasurface elements are rectangular and at least one metasurface element has a different length and/or width than another metasurface element of the metasurface elements.

In some aspects, the techniques described herein relate to a metasurface device, wherein the metasurface elements are elliptical.

In some aspects, the techniques described herein relate to a metasurface device, wherein the metasurface elements are arranged in a rectangular grid.

In some aspects, the techniques described herein relate to a metasurface device, wherein the metasurface elements are arranged in a hexagonal grid.

In some aspects, the techniques described herein relate to a metasurface device, wherein the rotation, of the metasurface elements at specific positions are defined by the following equation: where, where, and where is the distance of the metasurface plane from the source emitting with spherical wavefront placed at.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates an example metasurface device for orthogonal polarizations without tuning.

FIG. 2A illustrates an example output from a VCSEL light source.

FIG. 2B is an illustration of change in axis of polarization state at plane.

FIG. 2C is an example polarization-switchable illumination device.

FIG. 3 illustrates the deleterious impact of not taking into consideration local polarization axis.

FIG. 4A illustrates an example metasurface device with alignment of the metasurface to local polarization axis in accordance with an embodiment of the invention.

FIG. 4B illustrates alignment of metasurface to local polarization axis with a varied metasurface library including different rectangular cross-sections in accordance with an embodiment of the invention.

FIG. 4C illustrates an example metasurface device where the metasurface elements are arranged in a hexagonal grid in accordance with an embodiment of the invention.

FIG. 4D illustrates an example metasurface device including metasurface elements including elliptical pillar cross-sectional shapes in accordance with an embodiment of the invention.

FIG. 5 illustrates an example metasurface unit cell aligned to a local polarization axis in accordance with an embodiment of the invention.

FIG. 6 illustrates an example metasurface unit cell with wavevector, kt labeled in accordance with an embodiment of the invention.

FIG. 7 is an example metasurface unit cell using Jones matrix calculus to derive alignment of the metasurface unit cell in accordance with an embodiment of the invention.

### DETAILED DESCRIPTION

Disclosed herein is optical devices and methods including polarization-tuned metasurface optics. The polarization-tuned metasurface optics may include geometrical birefringence introduced intentionally by breaking the rotational symmetry of constituent metasurface elements or pillars. Certain embodiments include a design principle and corresponding adjustments to the layout of a metasurface design to ensure minimal cross-talk under illumination by two orthogonal polarizations with a non-collimated light source such as a light source including one or more divergent wavefronts. For example, the non-collimated light source may have a non-collimated and/or a spherical wavefront. The spherical wavefront may induce a local “polarization skew aberration” with respect to the metasurface plane, which may be adjusted for in the design process by rotating the metasurface elements into alignment with the local spherical coordinate system. The metasurface elements may have geometric birefringence.

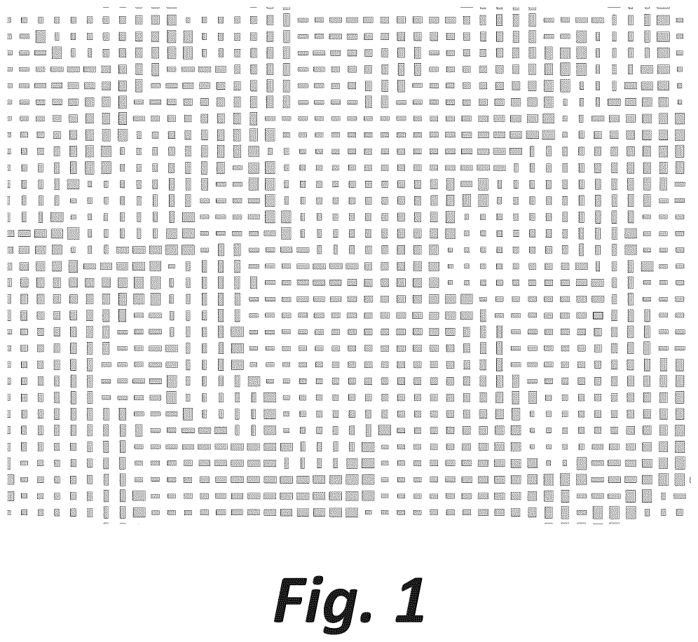

FIG. 1 illustrates an example metasurface device for orthogonal polarizations without tuning. The metasurface device may be utilized for polarization-switchable illumination of a scene through projection of each polarization state or channel to a distinct illumination pattern. The metasurface device may be designed for two orthogonal polarization states. FIG. 1 is a magnified view of the microscopic structure of the metasurface device including multiple metasurface elements having rectangular cross-sections. Alternate embodiments may include metasurface elements having an elongated or oval cross-sections, or other non-symmetrical cross-sections. In this configuration, the base metasurface library is targeting two orthogonal linear polarization states, though in general the orthogonal polarization states need not be linear. For a collimated beam, this design with a manhattan grid without rotation of the metasurface elements may be utilized. However, because the metasurface unit cell is aligned to the polarization axes, for incident illumination of a non-collimated or curved (e.g. spherical) wavefront, the out-going radiation polarization may not be perfectly aligned to the eigen-polarization states of the unit cell at a given location and cross-talk may result, lowering the efficiency of the output and/or producing overlapping output patterns.

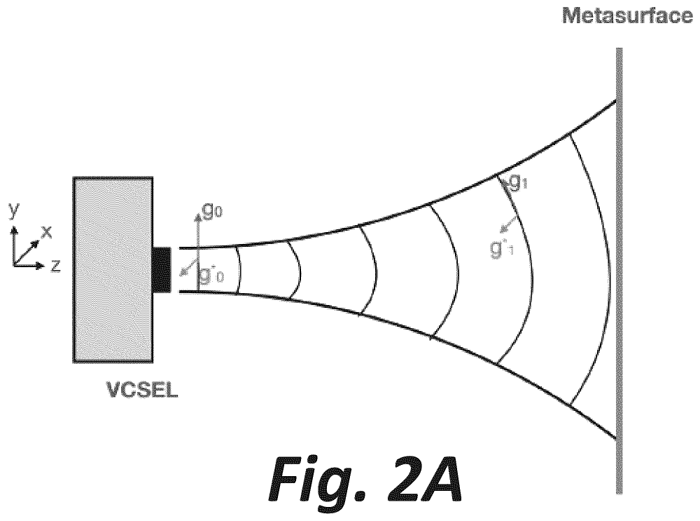

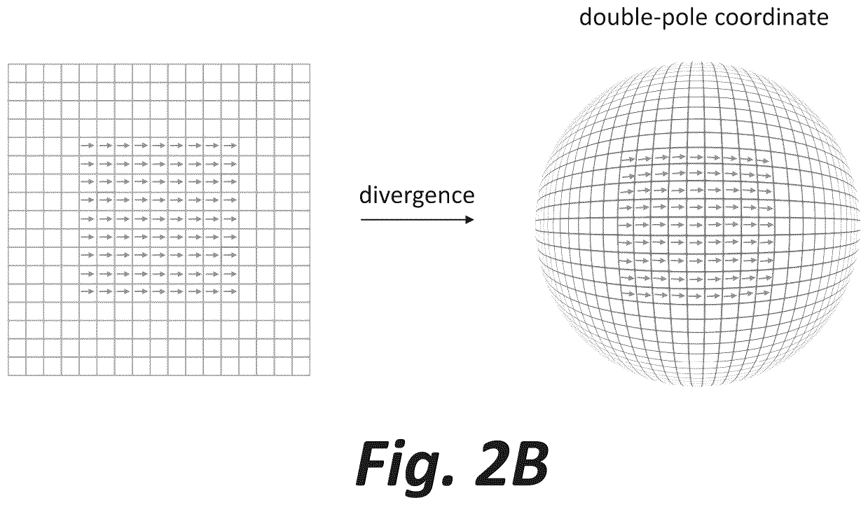

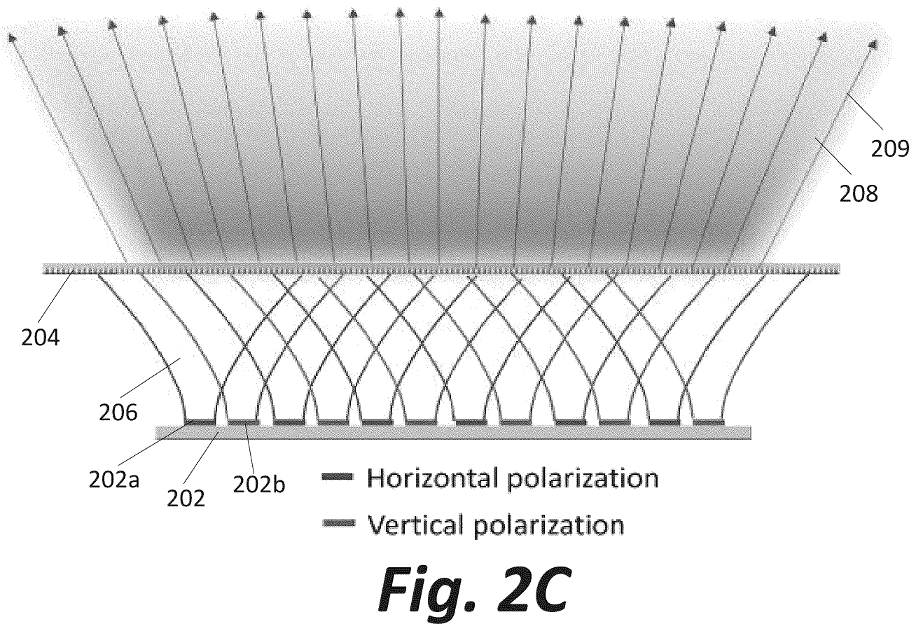

Light sources such as a vertical-cavity surface-emitting laser (VCSEL) or a LED light source may include a divergent light source moving further away from the aperture and thus create a spherical wavefront. An array of VCSEL light sources may be utilized to create a VCSEL array. FIG. 2A illustrates an example output from a VCSEL light source. As illustrated, a spherical wavefront is incident on the metasurface. FIG. 2B is an illustration of change in axis of polarization state at plane. Due to the local curvature, spherical wavefronts may have a polarization axis which follows the grid curvature of a “double-pole” coordination system. The “double-pole” coordinate system is the grid rendered on a sphere in which two poles of the spherical coordinate system to the southernmost point of the sphere. FIG. 2B essentially shows the double-pole coordinate system. The arrows are aligned in the middle and slightly tilted along the curved portions conforming to the curved grid on the sphere.

Relative to a flat plane, the spherical wavefront may cause a skew of the axes at points on the plane far from the origin, particularly along the curved portions. FIG. 2C is an example polarization-switchable illumination device. The illumination device includes a VCSEL array 202 which includes interlaced vertical polarization VCSELs 202a and horizontal polarization VCSELs 202b. These VCSELs 202a, 202b output light 206 including two orthogonal polarizations with a spherical wavefront which is incident on a metasurface 204. The metasurface produces two distinct output light beams, a first light beam 208 and a second light beam 209, at separate times. The first light beam 208 may be produced by activating the vertical polarization VCSELs 202a and the second light beam 209 may be produced by activating the horizontal polarization VCSELs 202b. The first light beam 208 corresponds to the vertical polarization channel and the second light beam 209 corresponds to the horizontal channel. Each polarization channel can be switched by selective addressing of odd and even VCSEL columns. In some embodiments, the orthogonal polarizations may be two orthogonal linear polarizations. In some embodiments, the orthogonal polarizations may be circular polarizations and/or elliptical polarizations with opposite orientations. In some embodiments, the first light beam 208 and the second light beam 209 may be utilized sequentially. In some embodiments, the first light beam 208 and the second light beam 209 may be utilized simultaneously.

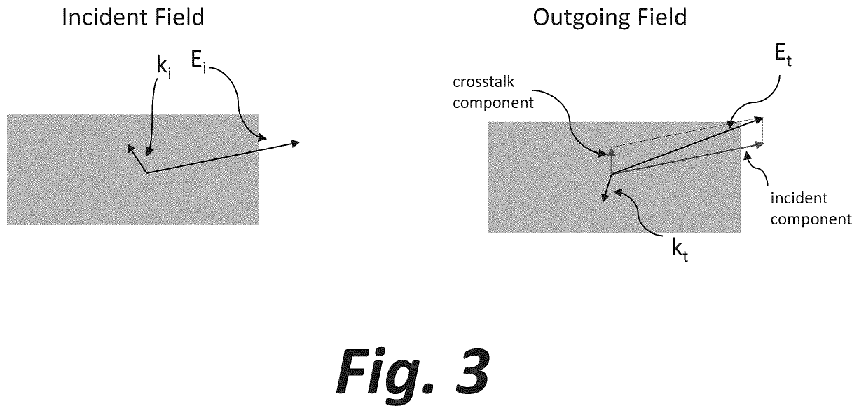

FIG. 3 illustrates the deleterious impact of not taking into consideration local polarization axis. During design, the metasurface unit cell may be chosen according to the phase shift it induces for the two orthogonal polarization linear states. If those two orthogonal linear polarization states do not take into account the spherical wavefront, then the designed element may induce a cross-polarization effect, as it mixes the incident, non-aligned polarization. When rays approach the metasurface unit at an oblique angle, the polarization may not be perfectly aligned with the width or length of the pillar which may create the above discussed crosstalk. Mixing of the input non-aligned polarization state with the output polarization may create the crosstalk. The output polarization may not be conserved in the presence of the crosstalk.

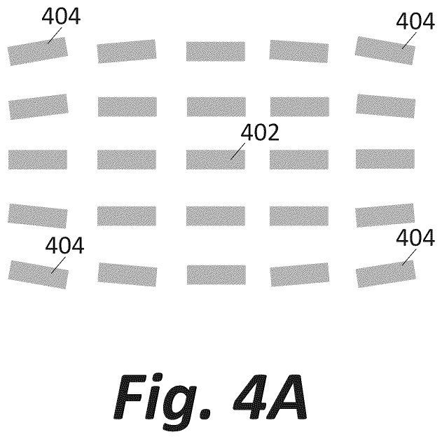

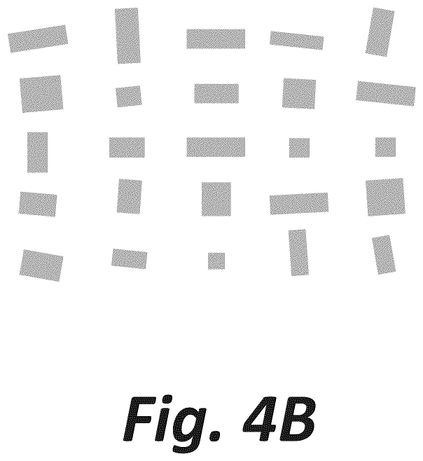

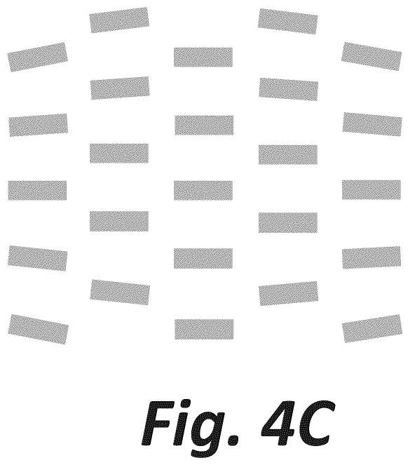

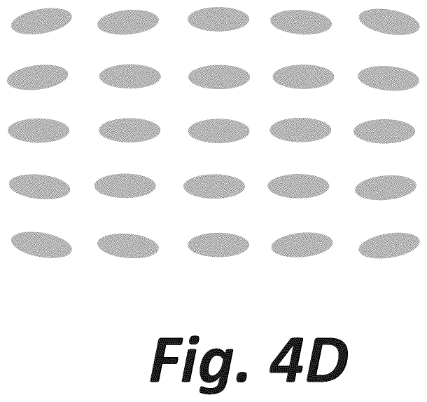

FIG. 4A illustrates an example metasurface device with alignment of the metasurface to local polarization axis in accordance with an embodiment of the invention. Rotation of the metasurface units to change the orientation of the metasurface units can adjust the eigen polarization states to match at least one of the eigen polarization states to one of local polarization axes of the diverging beam. VCSEL array emitters that gives rise to a spherical wavefront or a divergent beam will benefit from this rotation of the metasurface units. Rotating metasurface units across the metasurface, the orientation and rotation angle may depend highly on the spherical wavefront of the VCSEL. There may be constant spacing between the metasurface elements across the metasurface device. Metasurface elements towards the center may be aligned to the nominal polarization directions, while those which are away from the origin (and in this configuration, along the curved portions), may be rotated with respect to the local coordinate frame for one of the polarizations. In the illustrated metasurface device, all rectangular cross-sections may be identical, but in other cases they may be different in shape (e.g., square, oval, crosses, etc.) or relative cross-sectional dimensions (i.e. length and width). The metasurface elements may include interior metasurface element(s) 402 which may be axis aligned and exterior metasurface elements 404 radiating outward which may be tilted more and more substantially as they are farther from the interior metasurface element(s) 402. Thus, metasurface elements on the fringes are more rotated.

In some embodiments the rectangular cross-sections may be varied. With a library of rectangular cross-sections, the axes of the rectangles may follow one of the local axes. FIG. 4B illustrates alignment of metasurface to local polarization axis with a varied metasurface library including different rectangular cross-sections in accordance with an embodiment of the invention. As illustrated, the metasurface elements can change orientation and size (e.g. width and length) across the metasurface device in order to allow for spatial control over the phase as well as polarization tuning.

In some embodiments, the metasurface device may be in rectangular or non-rectangular (e.g. hexagonal) grid. FIG. 4C illustrates an example metasurface device where the metasurface elements are arranged in a hexagonal grid in accordance with an embodiment of the invention.

In some embodiments, the metasurface elements of the metasurface device may include different cross-sectional shapes. FIG. 4D illustrates an example metasurface device including metasurface elements including elliptical pillar cross-sectional shapes in accordance with an embodiment of the invention.

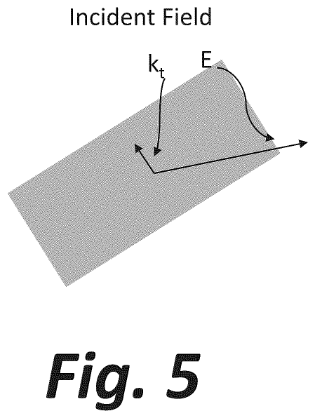

FIG. 5 illustrates an example metasurface unit cell aligned to a local polarization axis in accordance with an embodiment of the invention. During design, the metasurface unit cell dimension may be chosen based on the phase shift it induces and may be also aligned to the transverse component of propagation direction of the incident light. This choice makes the metasurface symmetric with respect to the incident light, and so the equivalent Jones matrix may be diagonal. Then, rotations of the incident polarization vector may be preserved. Shown is the transverse component of the wavevector, kₜ (e.g. the component of the wavevector k projected onto the xy-plane).

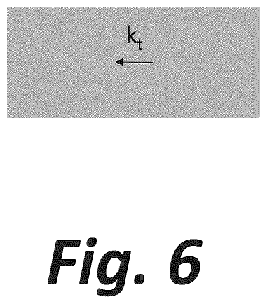

FIG. 6 illustrates an example metasurface unit cell with wavevector, kₜ labeled in accordance with an embodiment of the invention. The Jones matrices of unit cells may be considered. Jones matrices may be calculated for a unit cell at different angles of incidence (denoted by z-component of the wavevector, k_{z}). Only angles of incidence in the plane of the symmetry of the unit cell may be considered. For each k_{z} of interest, the resulting Jones matrix may be calculated, which may be diagonal in the linear polarization basis because of the rectangular symmetry of the unit cell and incident field. U.S. Pat. App. Pub. No. 2022/0091428, entitled “Transmissive Metasurface Lens Integration” and filed Dec. 7, 2021, and U.S. Pat. App. Pub. No. 2021/0286188, entitled “Arbitrary polarization-switchable metasurfaces” and filed Feb. 22, 2019 discuss details about the Jones matrix of metasurface unit cells including metasurface elements. These references are incorporated by reference in their entirety for all purposes.

When used for design, the Jones matrix may then be diagonal and unitary, as illustrated, and a particular phase for the two polarizations may be targeted by utilizing φ₁ and φ₂ which are set by the dimensions of the unit cell:

$$[ \begin{matrix}{e}^{i {φ}_{1}} & 0 \\ 0 & {e}^{i {φ}_{2}}\end{matrix} ] \to [ \begin{matrix}{e}^{i {φ}_{1} ( {k}_{z} )} & 0 \\ 0 & {e}^{i {φ}_{2} ( {k}_{z )}}\end{matrix} ] \qquad ( 1 )$$

φ₁ and φ₂ are phase shifts on linearly polarized light along the fast axis and slow axis of the metasurface.

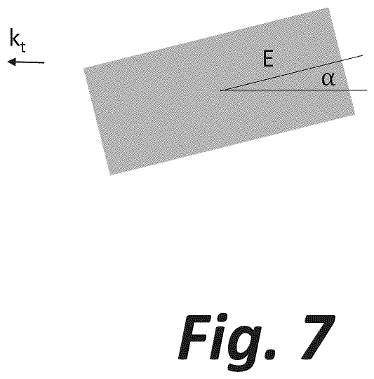

FIG. 7 is an example metasurface unit cell using Jones matrix calculus to derive alignment of the metasurface unit cell in accordance with an embodiment of the invention. For incident polarizations which are not aligned to the symmetry axis, the Jones matrix may be rotated (assuming the Jones matrix is equivalent under rotational symmetry, ignoring the lattice it is embedded in). Then, the outgoing polarization may be diagonal in the original basis, and then finally rotated back to the E-field's original frame. Viewed in this way, the outgoing linear polarization may be independently controlled by the unit cell design choice as given in φ₁ and φ₂, and the phase functions to be implemented in the metasurface can be independently specified.

$$J ( α ; {k}_{z} ) = R ( α ) [ \begin{matrix}{e}^{i {φ}_{1} ( {k}_{z} )} & 0 \\ 0 & {e}^{i {φ}_{2} ( {k}_{z} )}\end{matrix} ] R ( - α ) \qquad ( 2 )$$

$$J ( α ; {k}_{z} ) E ( α ) = R ( α ) [ \begin{matrix}{e}^{i {φ}_{1} ( {k}_{z} )} & 0 \\ 0 & {e}^{i {φ}_{2} ( {k}_{z} )}\end{matrix} ] R ( - α ) R ( α ) {E}_{0} = R ( α ) J ( 0 , {k}_{z} ) {E}_{0} \qquad ( 3 )$$

where R(α) is the rotation matrix for rotation by an angle of α. In these equations, the Jones matrix may be diagonal for the oblique k-vector.

The rotation α(x,y) of the metasurface elements at specific positions are defined by the following equation:

$$α ( x , y ) = arctan ( \frac{- sin ( {ϕ}_{0} ( x , y ) ) cos ( {ϕ}_{0} ( x , y ) ) ( 1 - cos ( {θ}_{0} ( x , y ) ) )}{cos ( {θ}_{0} ( x , y ) ) + sin {( {ϕ}_{0} ( x , y ) )}^{2} ( 1 - cos ( {θ}_{0} ( x , y ) ) )} ) \qquad ( 5 )$$

$$Where : {ϕ}_{0} ( x , y ) = sgn ( y ) arccos ( \frac{x}{\sqrt{{x}^{2} + {y}^{2}}} ) \qquad ( 6 )$$

$${θ}_{0} ( x , y ) = arccos ( {z}_{0} / \sqrt{{x}^{2} + {y}^{2} + {z}_{0}^{2}} ) \qquad ( 7 )$$

in which z₀ is the distance of the metasurface plane from the source emitting with spherical wavefront placed at (x,y)=(0,0). The ‘sgn’ operator refers to the sign function which will be +1 for positive arguments and will be −1 for negative arguments.

The Jones matrix may depend on the structure of the unit cell based on the metasurface dimensions and the structure of the light source. φ₁ may be the phase response dictated by the metasurface dimensions. The Jones matrix may capture non-intuitive effects caused by coupling between adjacent elements and the lattice that the unit cells are embedded in.

Metasurface devices including rotated metasurface elements have been previously disclosed in connection with elliptical polarization states. For example, U.S. Pat. Pub. No. 2021/0286188, entitled “Arbitrary polarization-switchable metasurfaces” and filed Feb. 22, 2019, discloses metasurfaces including tilted metasurface elements which may be utilized for elliptical polarized light. However, previous rotated metasurface elements have not been connected with integration with light sources including a divergent spherical wavefront. The disclosed invention relates to rotated metasurface elements adapted for use with non-collimated light sources such as light sources with a spherical wavefront.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A metasurface device comprising:
a metasurface including multiple metasurface elements configured to receive light including at least one of a first polarization or a second polarization with a diverging wavefront from a light source,
wherein the first polarization and the second polarization are orthogonal,
wherein the metasurface elements include an interior metasurface element which is substantially aligned to an axis and exterior metasurface elements which are rotated with respect to the axis,
wherein the exterior metasurface elements positioned farther away from the interior metasurface element are more rotated than the exterior metasurface elements positioned closer to the interior metasurface element, and
wherein the metasurface is configured to diffract light with the first polarization into a first output light beam and/or light with the second polarization into a second output light beam.

2. The metasurface device of claim 1, wherein the light source comprises a VCSEL array.

3. The metasurface device of claim 2, wherein the VCSEL array comprises interlaced vertical polarization VCSELs and horizontal polarization VCSELs which output light with a spherical wavefront.

4. The metasurface device of claim 3, wherein the VCSEL array is configured to switch between light source is configured to output light from the vertical polarization VCSELs or the horizontal polarization VCSELs at distinctly different times.

5. The metasurface device of claim 4, wherein the first output light beam has a different illumination pattern than the second output light beam.

6. The metasurface device of claim 5, wherein the first output light beam has a more dispersed illumination pattern than the second output light beam.

7. The metasurface device of claim 2, wherein the VCSEL array comprises interlaced first polarization VCSELs and second polarization VCSELs, and wherein the first polarization VCSELs and second polarization VCSELs output light with opposite polarizations.

8. The metasurface device of claim 7, wherein the first polarization VCSELs and the second polarization VCSELs output circularly polarized light.

9. The metasurface device of claim 7, wherein the first polarization VCSELs and the second polarization VCSELs output elliptically polarized light.

10. The metasurface device of claim 1, wherein the light received by the metasurface has a non-collimated wavefront.

11. The metasurface device of claim 1, wherein the metasurface elements are rectangular with identical length and width.

12. The metasurface device of claim 1, wherein the metasurface elements are rectangular and at least one metasurface element has a different length and/or width than another metasurface element of the metasurface elements.

13. The metasurface device of claim 1, wherein the metasurface elements are elliptical.

14. The metasurface device of claim 1, wherein the metasurface elements are arranged in a rectangular grid.

15. The metasurface device of claim 1, wherein the metasurface elements are arranged in a hexagonal grid.

16. The metasurface device of claim 1, wherein the rotation, α(x,y), of the metasurface elements at specific positions are defined by the following equation:
$$α ( x , y ) = arctan ( \frac{- sin ( {ϕ}_{0} ( x , y ) ) cos ( {ϕ}_{0} ( x , y ) ) ( 1 - cos ( {θ}_{0} ( x , y ) ) )}{cos ( {θ}_{0} ( x , y ) ) + sin {( {ϕ}_{0} ( x , y ) )}^{2} ( 1 - cos ( {θ}_{0} ( x , y ) ) )} )$$
$$where {ϕ}_{0} ( x , y ) = sgn ( y ) ( \frac{x}{\sqrt{{x}^{2} + {y}^{2}}} ) ,$$
$$where {θ}_{0} ( x , y ) = arccos ( {z}_{0} / \sqrt{{x}^{2} + {y}^{2} + {z}_{0}^{2}} ) ,$$
and
where z₀ is the distance of the metasurface plane from the source emitting with spherical wavefront placed at (x,y)=(0,0).
